(19) United States
(12) Patent Application Publication
(10) Pub. No.: US 2007/0115308 A1
(43) Pub. Date: May 24, 2007

(54) Liquid quantity sensing device

(75) Inventors: Taishi Hisano, Tokyo (JP); Akihiro Ozeki, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/598,855

(22) Filed: Nov. 14, 2006

(30) Foreign Application Priority Data
Nov. 24, 2005 (JP) P2005-338799

(51) Int. Cl. B41J 2/195

(52) U.S. Cl. 347/7

(57) ABSTRACT

According to one embodiment, a liquid quantity sensing device comprises a sensor body, a first electrode, a plurality of second electrodes and a sensing mechanism. The sensor body extends toward an interior of a container and includes electrically conductive material. The first electrode is disposed on the sensor body while the plurality of second electrodes are disposed on the sensor body and are separated from each other in a movement direction of a liquid level that changes according to a quantity of the liquid. The sensing mechanism senses conduction states between the respective second electrodes and the first electrode. At least one of the first electrode and an uppermost electrode of the second electrodes is separated from the upper wall by a distance larger than a maximum thickness of a liquid drop that adheres to the upper wall.

### CROSS-REFERENCE TO RELATED APPLICATIONS

This application is based upon and claims the benefit of priority from Japanese Patent Application No. 2005-338799, filed Nov. 24, 2005, the entire contents of which are incorporated herein by reference.

### BACKGROUND

1. Field

One embodiment of the invention relates to a liquid quantity sensing device which uses multiple electrodes to sense the quantity of liquid stored in a container, and more particularly to an arrangement of the electrodes.

2. Description of the Related Art

An apparatus such as a fuel cell unit or an inkjet printer includes a container, which stores liquid therein. Sometimes, a liquid quantity sensor which senses the quantity of liquid stored in the container, is disposed in such a container.

For example, Japanese Patent Application Publication (KOKAI) No. 2003-291367 and U.S. Pat. No. 7,059,696 disclose a liquid remaining quantity displaying device which senses the remaining quantity of an ink stored in a container. The liquid remaining quantity displaying device has electrode sections, voltage applying means, and liquid sensing means. The electrode sections are placed respectively at multiple positions in the container which stores liquid, and, when in contact with the liquid, are set to a conductible state. The voltage applying means applies a voltage to the electrode sections. The liquid sensing means senses the presence or absence of the liquid at the positions of the electrode sections, based on the conduction states of the electrode sections when the voltage is applied.

### BRIEF DESCRIPTION OF THE SEVERAL VIEWS OF THE DRAWINGS

A general architecture that implements the various feature of the invention will now be described with. reference to the drawings. The drawings and the associated descriptions are provided to illustrate embodiments of the invention and not to limit the scope of the invention.

FIG. 1 is an exemplary perspective view of a fuel cell unit according to a first embodiment of the invention;

FIG. 2 is an exemplary perspective view showing a state where a portable computer is mounted on the fuel cell unit shown in FIG. 1;

FIG. 3 is an exemplary perspective view of a DMFC unit according to the first embodiment of the invention;

FIG. 4 is an exemplary section view diagrammatically showing the interior of the fuel cell unit shown in FIG. 1;

FIG. 5 is an exemplary perspective view of a mixing section shown in FIG. 3;

FIG. 6 is an exemplary section view diagrammatically showing the mixing section shown in FIG. 3;

FIG. 7 is an exemplary view diagrammatically showing the operation principle of a liquid quantity sensor shown in FIG. 6;

FIG. 8 is an exemplary section view showing a state where a liquid drop adheres to an upper wall of a mixing tank shown in FIG. 6;

FIG. 9 is an exemplary section view showing a state where a liquid drop is detached from the upper wall of the mixing tank shown in FIG. 6;

FIG. 10 is an exemplary section view showing a state where the mixing tank shown in FIG. 6 is filled;

FIG. 11 is an exemplary section view diagrammatically showing a mixing section according to a second embodiment of the invention;

FIG. 12 is an exemplary section view diagrammatically showing a mixing section according to another embodiment of the invention;

FIG. 13 is an exemplary section view diagrammatically showing a mixing section according to a third embodiment of the invention;

FIG. 14 is an exemplary section view diagrammatically showing a mixing section according to a fourth embodiment of the invention; and

FIG. 15 is an exemplary section view diagrammatically showing a mixing section according to a further embodiment of the invention.

### DETAILED DESCRIPTION

Various embodiments according to the invention will be described hereinafter with reference to the accompanying drawings. In general, according to one embodiment of the invention, there is provided a liquid quantity sensing device including: a container that stores electrically conductive liquid, the container including an upper wall; a sensor body that is attached to the upper wall of the container and that extends toward an interior of the container; a first electrode that is disposed on the sensor body; a plurality of second electrodes that are disposed on the sensor body and are separated from each other in a movement direction of a liquid level that changes according to a quantity of the liquid; and a sensing mechanism that senses conduction states between the respective second electrodes and the first electrode. At least one of the first electrode and an uppermost electrode of the second electrodes is separated from the upper wall by a distance larger than a maximum thickness of a liquid drop that adheres to the upper wall.

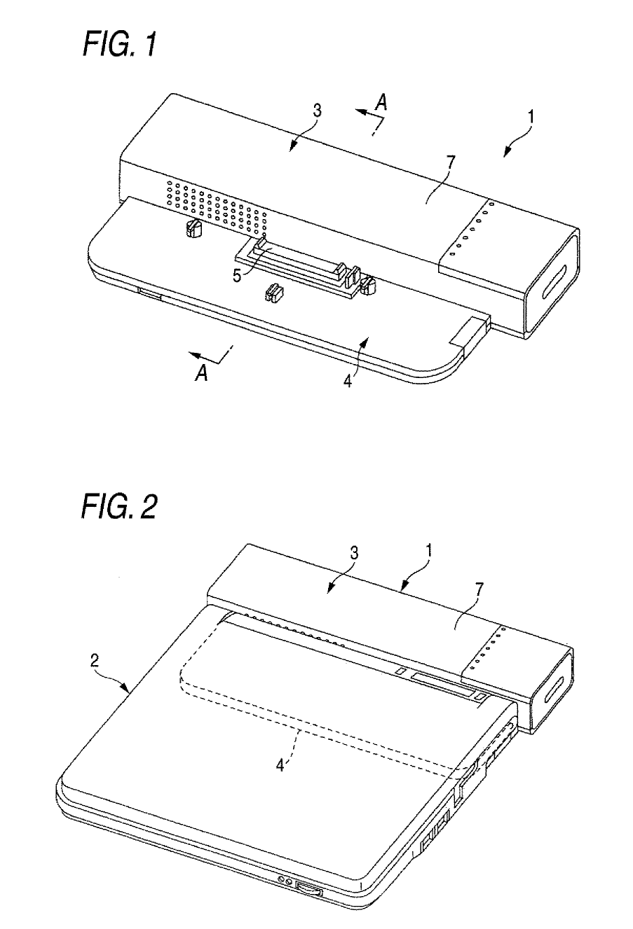

FIGS. 1 to 10 show a fuel cell unit 1 of a first embodiment of the invention. FIG. 1 discloses an exemplary embodiment of a liquid quantity sensing device, namely the fuel cell unit 1. For example, the fuel cell unit 1 is a direct methanol fuel cell (DMFC) device in which a methanol aqueous solution is used as a fuel. As shown in FIG. 2, the fuel cell unit 1 has a size which allows the unit to be used as a power source of, for example, a portable computer 2.

As shown in FIG. 1, the fuel cell unit 1 has a device body 3 and a stand portion 4. The device body 3 is formed into a slender shape which extends in the width direction of the portable computer 2. The stand portion 4 horizontally projects from the front end of the device body 3 so that a rear end portion of the portable computer 2 can be placed on the stand portion. A power source connector 5 is placed on the upper face of the stand portion 4. When the portable computer 2 is placed on the stand portion 4, the power source connector 5 is electrically connected to the portable computer 2.

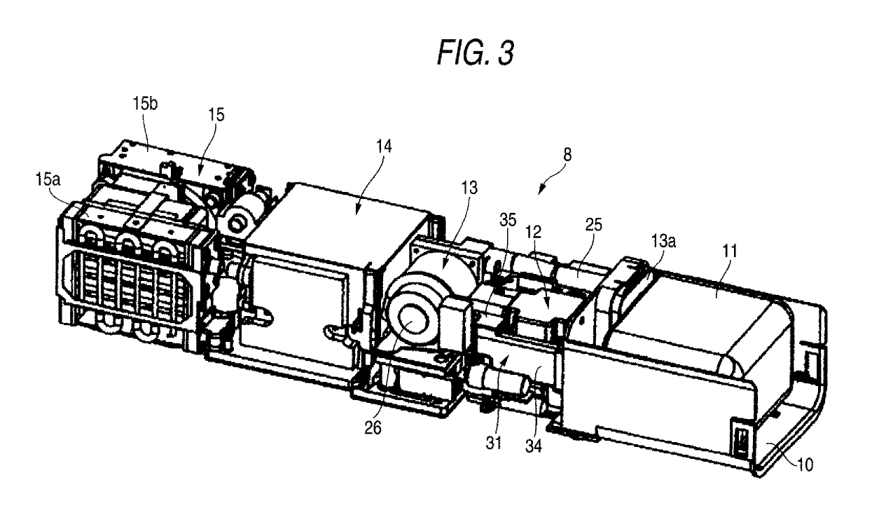

As shown in FIG. 1, the device body 3 includes a housing 7. The housing 7 houses a DMFC unit 8 shown in FIG. 3, therein. The DMFC unit 8 includes a holder 10, a fuel cartridge 11, a mixing section 12, an air intake section 13, a DMFC stack 14, a cooling section 15, and a controlling section 16.

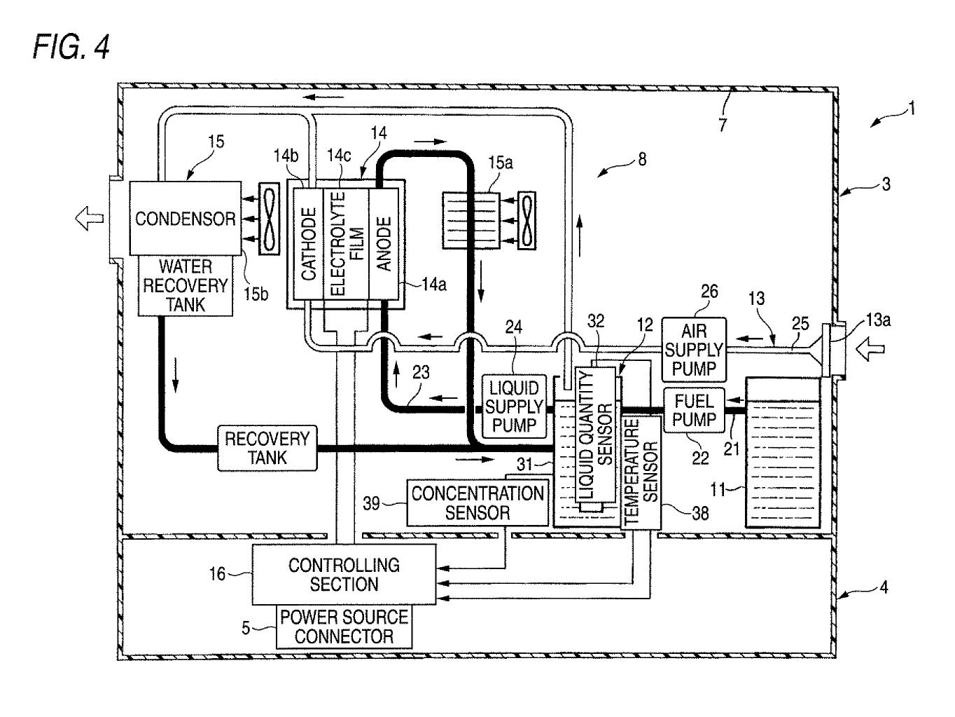

First, the whole DMFC unit 8 will be described with reference to FIGS. 3 and 4.

As shown in FIG. 3, the fuel cartridge 11 is detachably attached to the holder 10. High-concentration methanol which is to be used in electricity generation is charged in the fuel cartridge 11. As shown in FIG. 4, the fuel in the fuel cartridge 11 is fed to the mixing section 12 through a fuel supply pipe 21 opened in the holder 10 and a fuel pump 22.

The mixing section 12 dilutes the high-concentration methanol supplied from the fuel cartridge 11 to produce a methanol aqueous solution having a concentration of, for example, several % to several tens % methanol. The methanol aqueous solution produced in the mixing section 12 is fed to the DMFC stack 14 through a liquid supply pipe 23 and a liquid supply pump 24.

As shown in FIGS. 3 and 4, the air intake section 13 has an air intake hole 13a which provides air to DMFC stack 14. The air intake section 13 takes external air into the DMFC unit 8 through the air intake hole 13a. This air is fed to the DMFC stack 14 through an air supply pipe 25 and an air supply pump 26.

The DMFC stack 14 is one example of an electromotive part. The DMFC stack 14 has an anode 14a, a cathode 14b, and an electrolyte film 14c. The DMFC stack 14 causes the methanol aqueous solution to chemically react with oxygen in the air, thus generating electricity. As a result of the electricity generating operation, carbon dioxide and water vapor are produced. The produced carbon dioxide and water vapor and unreacted methanol are fed to the cooling section 15.

The cooling section 15 has a first cooling mechanism 15a and a second cooling mechanism 15b. The first cooling mechanism 15a cools the carbon dioxide and unreacted methanol aqueous solution which have passed through the anode 14a. The second cooling mechanism 15b cools the water vapor and air which have passed through the cathode 14b.

Part of the water, which has been cooled to return to the liquid state, and the methanol aqueous solution are recirculated to the mixing section 12 so that they can be used in production of methanol aqueous solution. The produced carbon dioxide is fed, together with the methanol aqueous solution, to the mixing section 12. Then the carbon dioxide is separated from the methanol aqueous solution in the mixing section 12 so that the carbon dioxide can be discharged to the outside of the DMFC unit 8.

As shown in FIG. 4, the controlling section 16 is housed in the stand portion 4. The controlling section 16 monitors the states of the mixing section 12, the air intake section 13, the DMFC stack 14, and the cooling section 15 and controls the operations of these units 12, 13, 14, and 15. The controlling section 16 supplies the electricity generated in the DMFC stack 14 to the power source connector 5.

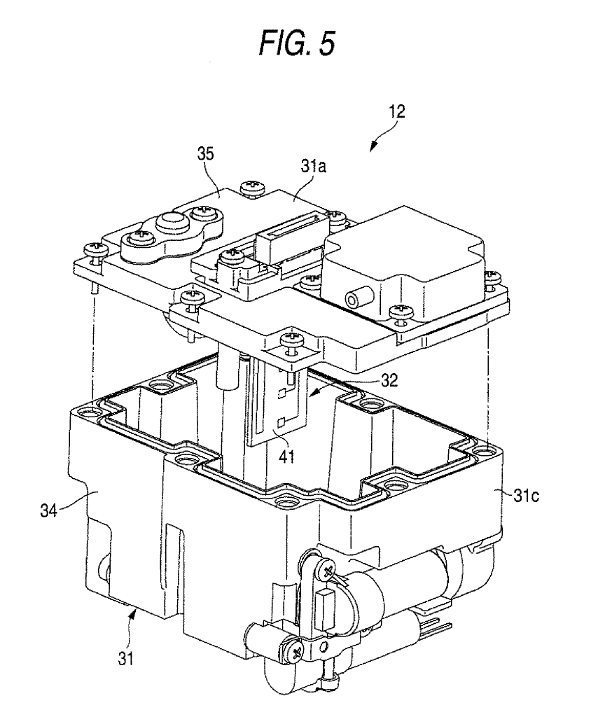

Next, the mixing section 12 will be described in detail with reference to FIGS. 5 to 7.

As shown in FIG. 5, the mixing section 12 includes a mixing tank 31 and a liquid quantity sensor 32. The mixing tank 31 is one example of the container. The mixing tank 31 has a tank body 34, and a cover 35 which covers the upper face of the tank body 34. The tank body 34 and the cover 35 cooperate with each other to form a box-like shape having an upper wall 31a, a bottom wall 31b, and a side wall 31c.

As shown in FIG. 4, the high-concentration methanol is supplied to the mixing tank 31 through the fuel supply pipe 21. Furthermore, water which has been recovered in the cooling section 15 is supplied to the mixing tank 31. The mixing tank 31 uses both the high-concentration methanol and the water to produce a methanol aqueous solution having a desired concentration and stores the produced methanol aqueous solution. The methanol aqueous solution is one example of the electrically conductive liquid.

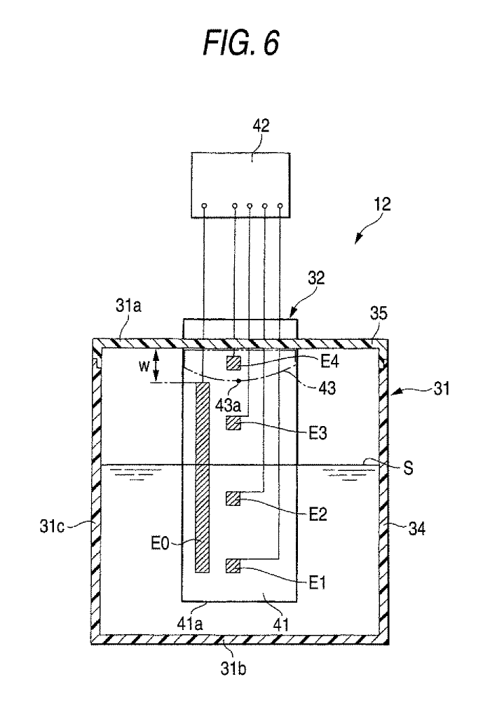

As diagrammatically shown in FIG. 6, the liquid quantity sensor 32 includes a sensor body 41, a reference electrode E0, first to fourth sensing electrodes E1, E2, E3, E4, and a sensing mechanism 42.

The sensor body 41 is attached to a middle portion of the upper wall 31a of the mixing tank 31. The sensor body 41 is formed into a plate-like shape and extends from the upper wall 31a toward the interior of the mixing tank 31. As shown in FIG. 6, the lower end 41a of the sensor body 41 is separated from the bottom wall 31b of the mixing tank 31.

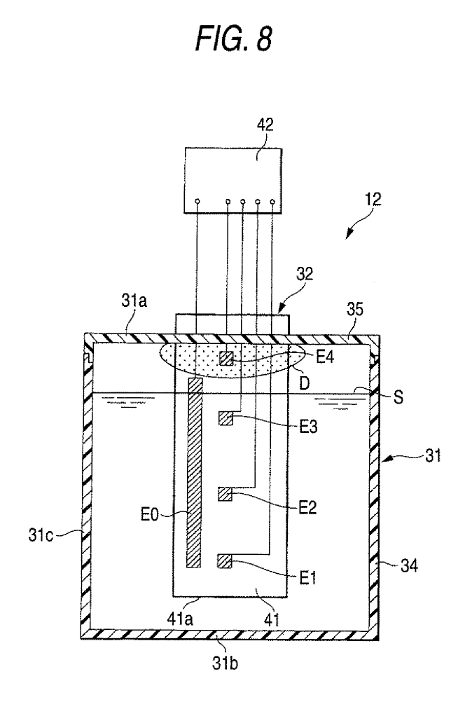

As shown in FIG. 8, when the methanol aqueous solution is stored in the mixing tank 31, a phenomenon sometimes occurs in which a liquid drop D of the methanol aqueous solution adheres to the inner face of the upper wall 31a. When the inner face of the upper wall 31a has convex portions, the adhering of the liquid drop D easily occurs in the concave and convex portions. In the mixing tank 31, therefore, such adhering occurs in an attachment portion between the upper wall 31a and the sensor body 41 as shown in FIG. 8. Furthermore, the size of the liquid drop D depends on the kind of liquid, particularly the viscosity of the liquid. When the kind of the liquid is identified, the maximum value of the adhering liquid drop D is specified.

As indicted by the one-dot chain line in FIG. 6, therefore, a region of the sensor body 41 which, when the liquid drop D adheres to the upper wall 31a, is presumed to be in contact with the liquid drop D is specified as a wetting region 43. In the case where the liquid drop D is fresh water, for example, the maximum thickness of the liquid drop D is about 3 millimeters (mm). In the specification, “maximum thickness of liquid drop” means the width of the maximum liquid drop D which may adhere to the upper wall 31a, extending from the upper wall 31a to the lower end of the liquid drop D.

Furthermore, research by the inventors has shown that the maximum thickness of the liquid drop D of a methanol aqueous solution having a concentration of several percentage (%) to several tens % methanol is smaller than that of the liquid drop D of fresh water. Namely, the maximum thickness of the liquid drop D of a methanol aqueous solution is smaller than 3 mm. In the embodiment, therefore, the distance between the upper wall 31a to the lower end 43a of the wetting region 43 is smaller than 3 mm.

As shown in FIG. 6, the reference electrode E0 is disposed in a left end portion of the sensor body 41 and extends in the same direction as the sensor body 41. The reference electrode E0 is one example of the first electrode. In the embodiment, only one reference electrode E0 is disposed. Alternatively, plural reference electrodes E0 may be separately disposed so as to correspond to the multiple sensing electrodes E1, E2, E3, E4, respectively.

As shown in FIG. 6, in order to prevent the reference electrode E0 from being in contact with the liquid drop D, the reference electrode is separated from the upper wall 31a by a distance w which is larger than the maximum thickness of the liquid drop D. In other words, the reference electrode E0 is disposed in a portion outside the wetting region 43.

Moreover, the upper end of the reference electrode E0 is positioned in the vicinity of the wetting region 43. Namely, the upper end of the reference electrode E0 is disposed in an upper end portion of a region which is not in contact with the liquid drop D. For example, the upper end of the reference electrode E0 is formed at a position which is separated from the upper wall 31a by 3 mm in the vertical direction.

The reference electrode E0 is exposed to the interior of the mixing tank 31. When the methanol aqueous solution is stored in the mixing tank 31, the reference electrode E0 is in contact with the methanol aqueous solution. The reference electrode E0 is electrically connected to the sensing mechanism 42.

As shown in FIG. 6, the first to fourth sensing electrodes E1, E2, E3 and E4 are arranged at intervals in the extension direction of the sensor body 41. In the embodiment, the extension direction of the sensor body 41 means the movement direction of a liquid level S according to a change of the quantity of the methanol aqueous solution. The first to fourth sensing electrodes E1 to E4 are one example of the second electrodes.

The first to fourth sensing electrodes E1 to E4 are placed respectively at plural heights which are set in the sensor body 41. Namely, one sensing electrode is placed at one liquid level. The term “liquid level” means a height index which is set in the sensor body 41 in order to indicate the height of the liquid level S.

The fourth sensing electrode E4 is placed in the vicinity of the upper wall 31a, and positioned in the wetting region 43. Namely, the fourth sensing electrode E4 is separated from the upper wall 31a by a distance which is smaller than the maximum thickness of the liquid drop D. In a manner similar to the reference electrode E0, the first to fourth sensing electrodes E1 to E4 are exposed to the interior of the mixing tank 31, and electrically connected to the sensing mechanism 42.

In order to isolate a wiring pattern, which electrically connects the sensing electrodes E0, E1, E2, E3, E4 to the sensing mechanism 42, from the methanol aqueous solution, the surface of the sensor body 41 is coated except portions where the sensing electrodes E0, E1, E2, E3, E4 are exposed. As the coating material, a material having a methanol resistance, water repellency, and electrical insulation is preferably used. For example, a parylene coating using a polyparaxylylene resin is preferably employed.

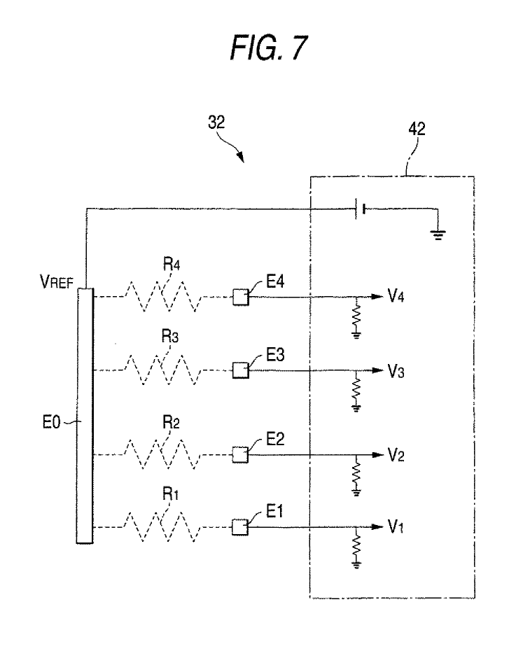

As diagrammatically shown in FIG. 7, the sensing mechanism 42 applies a reference voltage V_{REF} to the reference electrode E0, and measures sensing voltages V₁, V₂, V₃, V₄ of currents passing through the first to fourth sensing electrodes E1, E2, E3, E4. Therefore, the sensing mechanism 42 can sense conduction states between the sensing electrodes E1, E2, E3, E4 and the reference electrode E0. In FIG. 7, R₁, R₂, R₃, and R₄ diagrammatically indicate the electric resistances between the first to fourth sensing electrodes E1 to E4 and the reference electrode E0, respectively.

When the sensing voltages V₁, to V₄ exceed a preset threshold, the sensing mechanism 42 determines that the corresponding first to fourth sensing electrodes E1 to E4 are positioned in the liquid. In the following description, a sensing voltage which exceeds the threshold is indicated by V=HIGH, and that which is lower than the threshold is indicated by V=LOW. The sensing mechanism 42 is set so that a sensing result of the lower side is preferentially employed unless the liquid levels transit stepwise.

As shown in FIG. 4, the mixing section 12 further includes: a temperature sensor 38 which senses the temperature of the methanol aqueous solution; and a concentration sensor 39 which senses the concentration of the methanol aqueous solution. Data which are sensed by the liquid quantity sensor 32, the temperature sensor 38, and the concentration sensor 39, and which relate to the liquid quantity are sent to the controlling section 16 and then used in the control of the operation of the fuel cell unit 1.

Next, the function of the fuel cell unit 1 will be described with reference to FIGS. 6 to 10.

For example, FIG. 6 shows a state where adhering of the liquid drop D does not occur, and the liquid level S is positioned between the second sensing electrode E2 and the third sensing electrode E3. At this time, between the reference electrode E0 and the third sensing electrode E3, and the reference electrode E0 and the fourth sensing electrode E4, a highly conductive material does not exist and the resistances R₃, R₄ are high. Therefore, a substantially no current flows between the reference electrode E0 and the third sensing electrode E3, and the reference electrode E0 and the fourth sensing electrode E4, and V₃=LOW and V₄=LOW are attained.

By contrast, a part of the reference electrode E0 and the first and second sensing electrodes E1, E2 are positioned in the liquid. Since the methanol aqueous solution exists between the reference electrode E0 and the first sensing electrode E1, and the reference electrode E0 and the. second sensing electrode E2, the resistances R₁, R₂ are considerably lower than resistances in the case where the reference electrodes are in the air. Therefore, a current flows between the reference electrode E0 and the first sensing electrode E1, and the reference electrode E0 and the second sensing electrode E2, and V₁=HIGH and V₂=HIGH are attained.

As a result, the liquid quantity sensor 32 can determine that the liquid level S is between the second sensing electrode E2 and the third sensing electrode E3. On the same principle, the liquid quantity sensor 32 can sense the liquid quantity in the five steps, or the height of the liquid level S is (i) below the first sensing electrode E1, (ii) between the first sensing electrode E1 and the second sensing electrode E2, (iii) between the second sensing electrode E2 and the third sensing electrode E3, (iv) between the third sensing electrode E3 and the fourth sensing electrode E4, or (v) above the fourth sensing electrode E4.

Next, the case where adhering of the liquid drop D to the upper wall 31a occurs will be described.

Even if adhering of the liquid drop D to the upper wall 31a occurs, when the liquid level S is below the third sensing electrode E3, V₃=LOW is attained, and hence erroneous sensing is suppressed.

For example, FIG. 8 shows a state where adhering of the liquid drop D occurs, and the liquid level S is positioned between the third sensing electrode E3 and the fourth sensing electrode E4. At this time, also the fourth sensing electrode E4 is in contact with the methanol aqueous solution, but the reference electrode E0 is not in contact with the liquid drop D. Therefore, the resistance R₄ between the reference electrode E0 and the fourth sensing electrode E4 is high. Consequently, V₄=LOW is attained. As a result, the liquid quantity sensor 32 senses that the liquid level S is between the third sensing electrode E3 and the fourth sensing electrode E4.

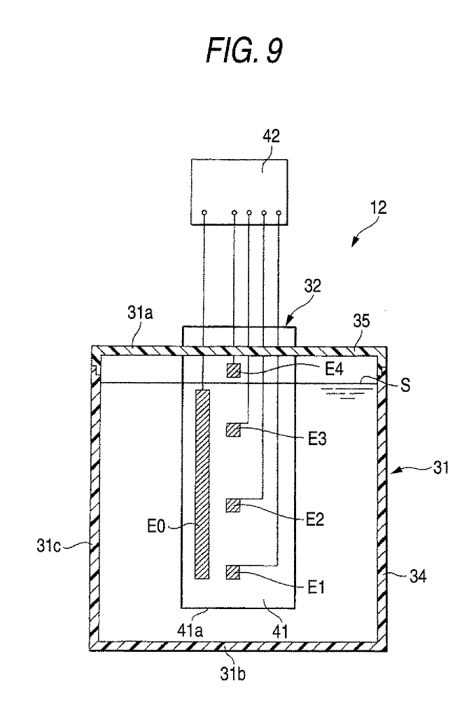

When the liquid quantity is further increased from the state shown in FIG. 8, the liquid level S is contacted with the lower end of the liquid drop D, and the liquid drop D is detached from the upper wall 31a so as to join with the other major portion of the methanol aqueous solution. The state where the liquid drop D is detached is shown in FIG. 9. In a state where the liquid drop D is detached, such as that shown in FIG. 9, the fourth sensing electrode E4 is exposed in the air, and hence V₄=LOW is attained. Therefore, the liquid quantity sensor 32 senses that the liquid level S is between the third sensing electrode E3 and the fourth sensing electrode E4.

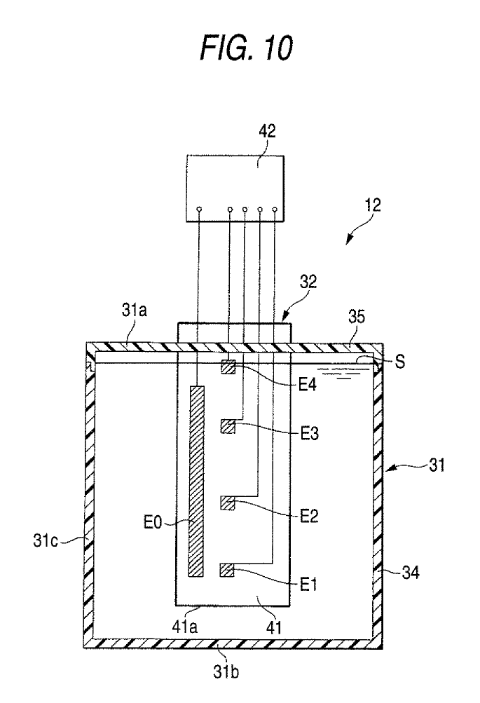

When the fourth sensing electrode E4 is immersed in the liquid as shown in, for example, FIG. 10, the gap between the reference electrode E0 and the fourth sensing electrode E4 is filled with the methanol aqueous solution, and the resistance R₄ between the reference electrode E0 and the fourth sensing electrode E4 is lowered, whereby V₄=HIGH is attained. Therefore, the liquid quantity sensor 32 senses that the liquid level S is above the fourth sensing electrode E4.

In the thus configured fuel cell unit 1, the accuracy of liquid quantity sensing can be enhanced. Namely, the reference electrode E0 in the embodiment is disposed at a position which, even when the liquid drop D adheres to the upper wall 31a, is not in contact with the liquid drop D. According to the configuration, even when the fourth sensing electrode E4 is in contact with the liquid drop D, erroneous sensing of the liquid quantity can be suppressed. Improvement of the sensing accuracy leads to stability of sensing in the liquid quantity sensor 32 and contributes to stability and safety of the operation control of the fuel cell unit 1.

In the embodiment, the reference electrode E0 is disposed at the position which is not in contact with the liquid drop D. Alternatively, the first to fourth sensing electrodes E1 to E4 may be disposed at positions which are not in contact with the liquid drop D. Also in the alternative, erroneous sensing is suppressed. Alternatively, all of the reference electrode E0 and the first to fourth sensing electrodes E1 to E4 may be disposed at positions which are not in contact with the liquid drop D.

In contrast, in the configuration where the fourth sensing electrode E4 is disposed in the vicinity of the upper wall 31a, the full state where the level of the methanol aqueous solution is near the upper wall 31a can be surely sensed. Namely, the liquid quantity can be sensed until the liquid level is positioned in the wetting region 43. Even when the reference electrode E0 is separated from the upper wall 31a, therefore, a large sensing range of the liquid level can be ensured.

Even when, for example, the reference electrode E0 is disposed in any portion, the above-described effects can be attained as far as the electrode is disposed outside the wetting region 43. When the upper end of the reference electrode E0 is placed in an upper end portion of the region which is not in contact with the liquid drop D, however, the distance between the reference electrode E0 and the fourth sensing electrode E4 can be reduced.

As the distance between the reference electrode E0 and the fourth sensing electrode E4 becomes shorter, the resistance R₄ between the reference electrode E0 and the fourth sensing electrode E4 when submerged in the liquid is lower. Namely, it is possible to determine more surely whether the reference electrode E0 and the fourth sensing electrode E4 are in the liquid or in the air. This contributes to improvement of the sensing accuracy of the liquid quantity sensor 32.

When the sensor body 41 is attached to the upper wall 31a, it is not required to dispose an opening or the like for attaching the liquid quantity sensor 32 in the bottom wall 31b, and hence liquid leakage from the bottom wall 31b can be prevented. When the lower end 41a of the sensor body 41 is separated from the bottom wall 31b, the methanol aqueous solution hardly stagnates in the mixing tank 31, and the concentration of the methanol aqueous solution is more uniform.

In the configuration where the sensor body 41 is attached to the middle portion of the upper wall 31a, even when the mixing tank 31 is inclined, the height change of the liquid level S is least. Namely, the liquid quantity sensor 32 is hardly affected by inclination of the liquid level S. Therefore, the disposition of the sensor body 41 in the middle portion of the upper wall 31a contributes to improvement of the accuracy of the sensing of the liquid quantity.

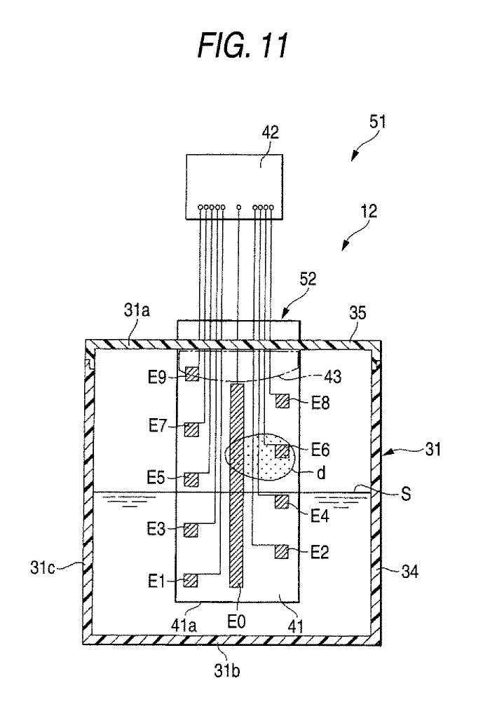

Next, a fuel cell unit 51 which is a liquid quantity sensing device of a second embodiment of the invention will be described with reference to FIG. 11. The components having the same function as those of the fuel cell unit 1 of the first embodiment are denoted by the same reference numerals, and their description is omitted.

A liquid quantity sensor 52 of the fuel cell unit 51 includes first to ninth sensing electrodes E1 to E9. The intervals of the first to ninth sensing electrodes E1 to E9 in the vertical direction are smaller than those in the liquid quantity sensor 32 of the first embodiment. The liquid quantity sensor 52 can sense a change of. the liquid quantity which is smaller than that in the case of the liquid quantity sensor 32 of the first embodiment.

As shown in FIG. 11, the first to ninth sensing electrodes E1 to E9 are alternately arranged on both sides of the reference electrode E0 in the horizontal direction that is orthogonal to the movement direction of the liquid level. Specifically, the first, third, fifth, seventh, and ninth sensing electrodes E1, E3, E5, E7 and E9 are placed on the left side of the reference electrode E0. The second, fourth, sixth, and eighth sensing electrodes E2, E4, E6 and E8 are placed on the right side of the reference electrode E0. The sensing electrodes E1 to E9 are separately arranged in different levels so as not to overlap with each other in the horizontal direction.

Next, the function of the fuel cell unit 51 will be described.

The principle of the liquid quantity sensing in the liquid quantity sensor 52 is identical with that in the liquid quantity sensor 32 in the first embodiment. The liquid quantity sensor 52 in the embodiment is characterized in that erroneous sensing can be suppressed when a liquid drop d adheres to the front of the sensor body 41.

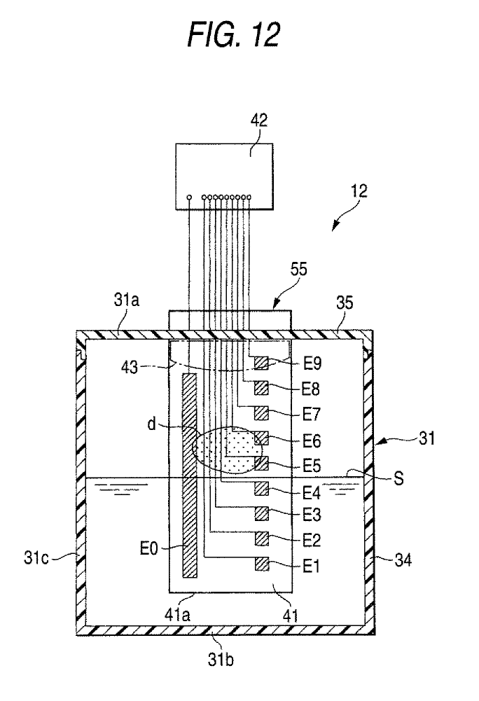

As further shown in FIG. 12, a liquid quantity sensor 55 in which the first to ninth sensing electrodes E1 to E9 are placed on one of the right and left sides of the reference electrode E0 may be used to sense small change of the liquid quantity,. For this embodiment of the liquid quantity sensor 55, however, there is a possibility that the liquid quantity is erroneously sensed when the liquid drop d adheres to a portion of the sensor body 41 which is immediately above the liquid level S.

In the state shown in FIG. 12, for example, the gaps between the fifth sensing electrode E5 and the reference electrode E0, and the sixth sensing electrode E6 and the reference electrode E0 are in a conduction state by the liquid drop d. Although the liquid level S is between the fourth sensing electrode E4 and the fifth sensing electrode ES, therefore, the liquid quantity sensor 55 may erroneously sense that the liquid level S is between the sixth sensing electrode E6 and the seventh sensing electrode E7.

In contrast, according to the liquid quantity sensor 52 in the embodiment, erroneous sensing of the liquid quantity can be suppressed even when the liquid drop d adheres to a portion immediately above the liquid level S as shown in FIG. 11. Namely, even when the reference electrode E0 passes current to the sixth sensing electrode E6, the reference electrode E0 does not pass current to the fifth sensing electrode E5, and hence the liquid quantity sensor 52 can correctly sense that the liquid level S is between the fourth sensing electrode E4 and the fifth sensing electrode E5.

According to the thus configured liquid quantity sensor 52, even when the interval between adjacent liquid levels is small, adjacent sensing electrodes can be largely separated from each other. According to the configuration, even when the liquid drop d adheres to a certain sensing electrode, the liquid drop d hardly adheres to a sensing electrode which is positioned at the adjacent liquid level. In the liquid quantity sensor 52, therefore, erroneous sensing can be suppressed even when the liquid drop d adheres to the front of the sensor body 41.

It is a matter of course that, also in the liquid quantity sensor 52 in the embodiment, erroneous sensing due to the liquid drop D adhering to the upper wall 31a can be suppressed in the same manner as the liquid quantity sensor 32 in the first embodiment.

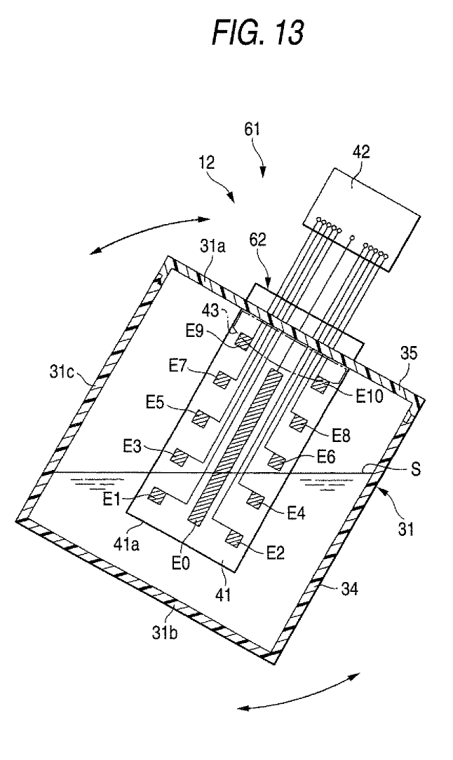

Next, a fuel cell unit 61 which is a liquid quantity sensing device of a third embodiment of the invention will be described with reference to FIG. 13. The components having the same function as those of the fuel cell unit 1 of the first embodiment are denoted by the same reference numerals, and their description is omitted.

A liquid quantity sensor 62 of the fuel cell unit 61 includes first to tenth sensing electrodes E1 to E10. As shown in FIG. 13, the first to tenth sensing electrodes E1 to E10 are placed separately on the right and left sides of the reference electrode E0 so that pairs of sensing electrodes are placed respectively at plural heights which are set in the sensor body 41.

Namely, the first and second sensing electrodes E1, E2 are placed at the same liquid level. Similarly, the third and fourth sensing electrodes E3, E4, the fifth and sixth sensing electrodes E5, E6, the seventh and eighth sensing electrodes E7, E8, and the ninth and tenth E9, E10 are placed at the respective same liquid levels.

Next, the function of the fuel cell unit 61 will be described.

The principle of the liquid quantity sensing in the liquid quantity sensor 62 is identical with that of the liquid quantity sensor 32 in the first embodiment. The embodiment is characterized in that, when the fuel cell unit 61 is inclined, the liquid quantity sensor 62 can sense also the inclination.

For example, FIG. 13 shows a state of the mixing section 12 when the fuel cell unit 61 is inclined. When the fuel cell unit 61 is inclined, the sensor body 41 is inclined with respect to the liquid level S. When the sensor body 41 is inclined with respect to the liquid level S, even in a pair of sensing electrodes which are placed at the same height in the sensor body 41, a state where one of the sensing electrodes is exposed in the air, and the other sensing electrode is submerged in the liquid is produced. In FIG. 13, for example, among the third and fourth sensing electrodes E3, E4 which are placed at the same height, the third sensing electrode E3 is exposed in the air, and the fourth sensing electrode E4 is submerged in the liquid.

According to the configuration, the liquid quantity sensor 62 can determine that the fuel cell unit 61 is inclined. Namely, the liquid quantity sensor 62 senses and considers the inclination of the liquid level S, so that the accuracy of liquid quantity sensing can be further improved. The number of sensing electrodes which are disposed at one liquid level is not restricted to two, and may be three or more.

It is a matter of course that, also in the liquid quantity sensor 62 in the embodiment, erroneous sensing due to the liquid drop D adhering to the upper wall 31a can be suppressed in the same manner as the liquid quantity sensor 32 in the first embodiment.

In the liquid quantity sensor 62, a plate face on which the sensing electrodes are arranged may be placed along the section A-A in FIG. 1 for the following reason. The fuel cell unit 61 attached to the portable computer 2 is often used while placed together with the portable computer 2 on the lap of the user. In such a case, the portable computer 2 is often inclined in the anteroposterior direction, and hence the fuel cell unit 61 is inclined along the section A-A in FIG. 1.

Alternatively, two or more liquid quantity sensor 62 which are disposed respectively along intersecting directions may be used, and the inclinations along the section A-A in FIG. 1 and a plane intersecting with the section A-A may be sensed. Alternatively, the sensor body 41 may have two plate faces which intersect with each other as viewed from the top, and three or more sensing electrodes may be disposed at each liquid level on the sensor body 41 to sense inclinations in two or more directions.

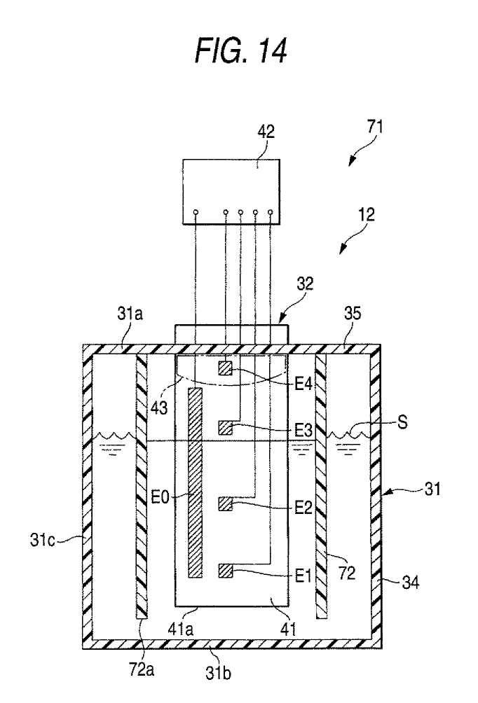

Next, a fuel cell unit 71 which is a liquid quantity sensing device of a fourth embodiment of the invention will be described with reference to FIG. 14. The components having the same function as those of the fuel cell unit 1 of the first embodiment are denoted by the same reference numerals, and their description is omitted.

The mixing tank 31 of the fuel cell unit 71 includes a partition 72. The partition 72 is one example an inner wall. The partition 72 is attached to the upper wall 31a and extends toward the interior of the mixing tank 31. The partition 72 is formed into, for example, a cylindrical shape. The partition 72 is disposed in (proximate to) the periphery of the sensor body 41 so as to surround the sensor body 41. The lower end 72a of the partition 72 is separated from the bottom wall 31b of the mixing tank 31, and the liquid can freely move between the outside and inside of the partition 72.

Next, the function of the fuel cell unit 71 will be described.

The principle of sensing the liquid quantity is identical with that of the liquid quantity sensor 32 in the first embodiment. The embodiment is characterized in that, even when an external factor such as vibration is applied to the fuel cell unit 71, lowering of the sensing accuracy of the liquid quantity sensor 32 can be suppressed.

In the case where vibration is applied to the fuel cell unit 71, the liquid level S swings in the mixing tank 31 as shown in FIG. 14. When the liquid level S swings, the sensing accuracy of the liquid quantity is lowered. When the partition 72 is disposed as shown in FIG. 14, however, the swing of the liquid level S around the liquid quantity sensor 32 is suppressed, whereby lowering of the sensing accuracy of the liquid quantity can be suppressed. The shape of the partition 72 is not restricted to a cylindrical shape and can have any structure as far as the partition surrounds the sensor body 41.

It is a matter of course that erroneous sensing due to the liquid drop D adhering to the upper wall 31a can be suppressed in the same manner as the liquid quantity sensor 32 in the first embodiment.

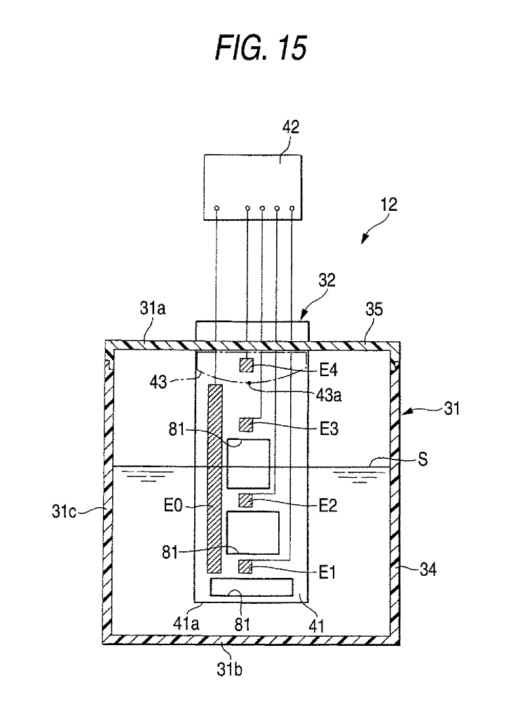

In the above, the fuel cell units 1, 51, 61, 71 of the first to fourth embodiments have been described. The invention is not restricted to the embodiments. As shown in FIG. 15, for example, openings 81 which pierce through the sensor body 41 may be disposed in portions of the sensor body 41 where the electrodes E0 to E4 are not disposed. Since the sensor body 41 has the openings 81, stagnation of the methanol aqueous solution in the mixing tank 31 can be further suppressed.

The components of the embodiments may be adequately combined with each other in a liquid quantity sensing device to which the invention is applied. The electrically conductive liquid is not restricted to methanol aqueous solution, and may be another liquid fuel such as alcohols, or an ink-like material. The range to which the invention can be applied is not restricted to a fuel cell unit, and may be applied to, for example, an ink container for an inkjet printer.

What is claimed is:

1. A liquid quantity sensing device including a container that stores electrically conductive liquid and includes an upper wall and a bottom wall, comprising:
a sensor body to extend toward an interior of the container;
a first electrode disposed on the sensor body;
a plurality of second electrodes disposed on the sensor body, the plurality of second electrodes being separated from each other in a direction from the upper wall to the bottom wall; and
a sensing mechanism to sense conduction states between each of the plurality of second electrodes and the first electrode,
wherein at least one of the first electrode and an uppermost electrode of the plurality of second electrodes is separated from the upper wall by a distance larger than a maximum thickness of a liquid drop of the liquid.

2. The liquid quantity sensing devices according to claim 1, wherein the plurality of second electrodes are oriented linear to each other.

3. The liquid quantity sensing device according to claim 1, wherein the first electrode is separated from the upper wall by the distance that is larger than the maximum thickness of the liquid drop, and the uppermost electrode of the plurality of second electrodes is separated from the upper wall by a distance that is smaller than the maximum thickness of the liquid drop.

4. The liquid quantity sensing device according to claim 1, wherein a lower end of the sensor body is separated from the bottom wall.

5. The liquid quantity sensing device according to claim 1, wherein the plurality of second electrodes are alternately placed on both sides of the first electrode substantially orthogonal to a direction that the sensor body extends.

6. The liquid quantity sensing device according. to claim 1, wherein at least two of the plurality of second electrodes are placed at a same height from the bottom wall of the container.

7. The liquid quantity sensing device according to claim 1, wherein the sensor body is attached at the center of the upper wall of the container.

8. The liquid quantity sensing device according to claim 1 further comprising an inner wall formed within the container and placed along at least a portion of a periphery of the sensor body.

9. A liquid quantity sensing device including a container that is adapted to store electrically conductive liquid and includes an upper wall and a bottom wall, comprising:
a sensor body to extend toward an interior of the container;
a first electrode disposed on the sensor body;
a plurality of second electrodes disposed on the sensor body, the plurality of second electrodes being separated from each other in a movement direction of a liquid level that changes according to a quantity of the liquid; and
a sensing mechanism to sense conduction states between each of the plurality of second electrodes and the first electrode,
wherein at least one of the first electrode and an uppermost electrode of the plurality of second electrodes is separated from the upper wall by at least three millimeters.

10. The liquid quantity sensing device according to claim 9, wherein the first electrode is separated from the upper wall by more than three millimeters, and the uppermost electrode of the plurality of second electrodes being separated from the upper wall by less than three millimeters.

11. The liquid quantity sensing device according to claim 9, wherein a lower end of the sensor body is separated from the bottom wall of the container.

12. The liquid quantity sensing device according to claim 9, wherein the plurality of second electrodes are alternately placed on both sides of the first electrode substantially orthogonal to the movement direction of the liquid level.

13. The liquid quantity sensing device according to claim 9, wherein at least two of the plurality of second electrodes are placed at a same height from the bottom wall of the container.

14. The liquid quantity sensing device according to claim 9, wherein the sensor body is attached to a middle portion of the upper wall of the container.

15. The liquid quantity sensing device according to claim 9, wherein the container includes an inner wall that is placed proximate to a periphery of the sensor body.

16. A liquid quantity sensing device including a container that is adapted to store-electrically conductive liquid and includes an upper wall and a bottom wall, comprising:
a sensor body to extend toward an interior of the container;
a first electrode disposed on the sensor body;
a plurality of second electrodes disposed on the sensor body, the plurality of second electrodes each being separated from the first electrodes;
a sensing mechanism to sense conduction states between each of the plurality of second electrodes and the first electrode,
wherein at least one of the first electrode and an uppermost electrode of the plurality of second electrodes is separated from the upper wall by a distance larger than a maximum thickness that a liquid drop of the liquid would occupy if the liquid drop adheres to the upper wall.

17. The liquid quantity sensing device according to claim 16, wherein the first electrode is separated from the upper wall by the distance that is larger than the maximum thickness of the liquid drop, and the uppermost electrode of the plurality of second electrodes is separated from the upper wall by a distance that is smaller than the maximum thickness of the liquid drop.

18. The liquid quantity sensing device according to claim 16, wherein a lower end of the sensor body is separated from the bottom wall.

19. The liquid quantity sensing device according to claim 16, wherein the distance between the upper most electrode of the first electrode is at least three millimeters.

20. The liquid quantity sensing device according to claim 16, wherein the container includes an inner wall that is placed in a periphery of the sensor body.
